(19) United States
(12) Patent Application Publication
(10) Pub. No.: US 2016/0237737 A1
(43) Pub. Date: Aug. 18, 2016

(54) WEATHERSTRIP HAVING UNDULATING BASE

(71) Applicant: Amesbury Group, Inc., Amesbury, MA (US)

(72) Inventors: Peter Mertinooke, Amesbury, MA (US); Mike May, Cannon Falls, MN (US); Gary Sleeman, Statesville, NC (US)

(73) Assignee: Amesbury Group, Inc., Amesbury, MA (US)

(21) Appl. No.: 15/043,307

(22) Filed: Feb. 12, 2016

Related U.S. Application Data
(60) Provisional application No. 62/116,228, filed on Feb. 13, 2015.

(51) Int. Cl. E06B 3/96; E06B 3/673; E06B 7/22

(52) U.S. Cl. CPC E06B 3/9616; E06B 7/22; E06B 3/673

(57) ABSTRACT

A pile weatherstrip has an elongate base portion. The base portion amplitude is greater than the base portion width. A pile extends from a central portion of the elongate base portion.

### CROSS-REFERENCE TO RELATED APPLICATIONS

This application claims priority to and the benefit of U.S. Provisional Patent Application No. 62/116,228, filed, Feb. 13, 2015, the disclosure of which is hereby incorporated by reference herein it its entirety.

### INTRODUCTION

Pile weatherstripping is inserted into slots in windows and/or door frames and provides a barrier to prevent the infiltration and/or exfiltration of air, water, insects, etc. A backing strip or backer of the pile weatherstripping is inserted to a corresponding slot in the frame during assembly. Too much friction between the backer and the slot can make insertion (and subsequent removal) of the weatherstripping difficult or impossible. Too little friction can result in movement between the base and the slot, which may result in the weatherstripping sliding out of the slot, causing a disruption to window manufacturing.

### SUMMARY

This summary is provided to introduce a selection of concepts in a simplified form that are further described below in the Detailed Description. This summary is not intended to identify key features or essential features of the claimed subject matter, is not intended to describe each disclosed embodiment or every implementation of the claimed subject matter, and is not intended to be used as an aid in determining the scope of the claimed subject matter. Many other novel advantages, features, and relationships will become apparent as this description proceeds. The figures and the description that follow more particularly exemplify illustrative examples.

In one aspect, the technology relates to a pile weatherstrip having: an elongate base portion having a base portion width and a base portion amplitude greater than the base portion width; and a pile extending from a central portion of the elongate base portion. In an embodiment, the base portion has a first deformation on a first side of the pile and a second deformation on a second side of the pile, and wherein the amplitude is measured from an outer limit of the first deformation to an outer limit of the second deformation. In another embodiment, the first deformation has a first deformation width extending from proximate the pile to the outer limit of the first deformation. In yet another embodiment, the first deformation has a first deformation length extending along the elongate base portion, wherein the first deformation length is greater than the first deformation width. In still another embodiment, a pile support extending from the elongate base portion, wherein the pile is bordered on at least one side by the pile support, and wherein the first deformation contacts the pile support.

In another embodiment of the above aspect, the base portion amplitude is about 120% to about 200% of the base portion width. In an embodiment, the first deformation length is about 100% to about 200% of the first deformation width.

In another aspect, the technology relates to a weatherstrip having: an undulating elongate base portion; and a pile extending from a central portion of the undulating elongate base portion. In an embodiment, the undulating elongate base portion has an effective width greater than an actual width of the undulating elongate base portion. In another embodiment, the undulating elongate base portion has a non-linear centerline. In yet another embodiment, the undulating elongate base portion has a plurality of deformations, wherein outer limits of the plurality of deformations define an amplitude of the undulating elongate base portion. In still another embodiment, the undulating elongate base portion undulates laterally. In another embodiment, the pile extends substantially orthogonal from the undulating elongate base portion.

In another aspect, the technology relates to a weatherstrip having: a substantially uniform elongate base portion having: a first edge; a second edge; and a first deformation formed in a portion of the first edge, wherein a portion of the second edge opposite the first deformation has a curvature. In an embodiment, a second deformation formed in a portion of the second edge, wherein a portion of the first edge opposite the second deformation has a curvature. In another embodiment, a pile extends from the substantially uniform elongate base portion and a pile director bordering the pile. In yet another embodiment, the deformation at least partially contacts the pile director. In still another embodiment, the deformation has a textured surface of the substantially uniform elongate base portion.

In another embodiment of the above aspect, the textured surface is formed in an upper surface of the substantially uniform elongate base portion. In an embodiment, a fin is disposed within the pile.

### BRIEF DESCRIPTION OF THE DRAWINGS

FIGS. 1A and 1B are top views and partial enlarged top views, respectively, of a weatherstrip in accordance with the prior art.

FIG. 2 depicts a perspective view of a weatherstrip in accordance with an example of the present technology.

FIG. 3 depicts a top view of a weatherstrip in accordance with an example of the present technology.

FIG. 4 depicts an end view of a weatherstrip in accordance with an example of the present technology.

FIG. 5 depicts a top view of a weatherstrip and a t-slot, prior to insertion of the weatherstrip.

FIG. 6 depicts a top view of the weatherstrip inserted into the t-slot.

### DETAILED DESCRIPTION

Retention technologies utilized in conjunction with pile or other weatherstrips help retain the weatherstrip in the t-slot of a window extrusion. The retention force results from contact and interference between the backing strip of the weatherstrip and the outer walls of the t-slot (typically the outer walls that define the width dimension). It is desirable that the weatherstrip display sufficient retention force so the weatherstrip does not slide out of the slot during window manufacturing processes. However, retention forces that are too high can cause other problems. For example, if the interference is too high, the weatherstrip may not be easily insertable into the t-slot. Once inserted, however, due to differences in material properties, the window frame extrusion and weatherstrip (namely, the backing strip thereof) expand and contract at different rates. As such, if the weatherstrip is held too firmly in the t-slot, the weatherstrip may be damaged as the window frame expands and contracts. Additionally, it is often necessary to remove the weatherstrip after manufacture to replace a damaged weatherstrip. As such, easy removal of the weatherstrip is also desirable. The technologies described herein can be used to retain weatherstrips utilizing pile, foam profiles, rigid plastic profiles, etc., in t-slots formed in door or window frames. For clarity, however, the technologies will be described in the context of pile weatherstrips.

Prior retention technologies incorporated into weatherstrips include those depicted and described in U.S. Pat. No. 5,438,802, the disclosure of which is hereby incorporated herein by reference herein in its entirety. These technologies include the formation of so-called “nubbins” in the weatherstrip base. The nubbin of U.S. Pat. No. 5,438,802 is described as a compression of material of the backing strip, which causes a circular, projecting surface to be formed along the edge of the backing strip. The presence of the nubbin purportedly restrains the backing strip in a T-slot of a window frame. Alternative technologies include circular or curved distortions that are formed by punching holes along the edges of the backing strip. In another example, hemispherically-shaped dimples can be formed along an underside of the backing strip. Another example depicts abrasions along the outer edge of the backing strip that form flaps. However, it has been determined that the above-described prior art do not function desirably when the weatherstrip is inserted into a T-slot of a window frame extrusion.

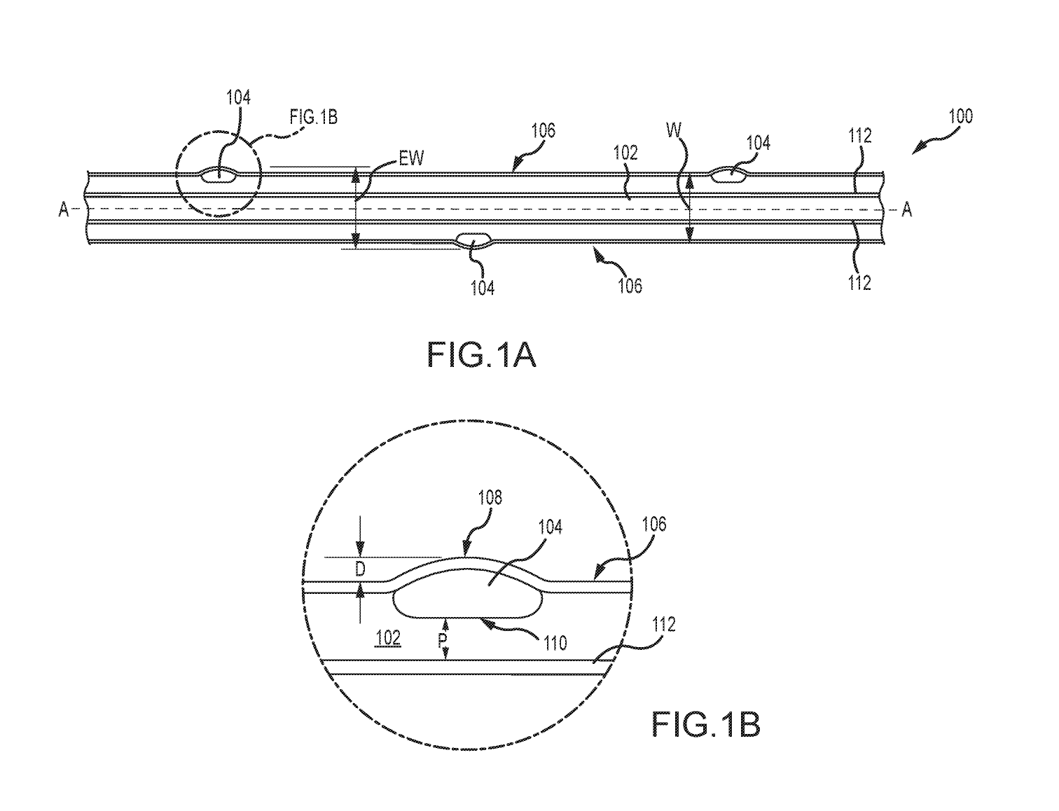

FIGS. 1A and 1B are top views and partial enlarged top views of a weatherstrip 100 manufactured in accordance with the prior art. FIG. 1A depicts a pile weatherstrip 100 (with the pile not depicted for clarity) having a backing strip 102 having a nominal width W. Deformations or tabs 104 are formed at alternating intervals along the edges 106 of the backing strip 102. The deformations 104 extend a distance D from the edge 106 of the backing strip 102 to an outer extent 108 of the deformation 104. As such, the effective width EW (measured between alternating outer extents 108) is the sum of the nominal width W, a distance D to one deformation, and a distance to an opposite deformation. Thus, the effective width may be described as the total lateral space that the weatherstrip 100 occupies. Additionally, the deformations 104 have an inner extent 110 that is spaced a distance P from the pile director 112 (which forms an outer border of the pile, as described below). Notably, after formation of the tabs 104, the backing strip 102 maintains a straight axis A.

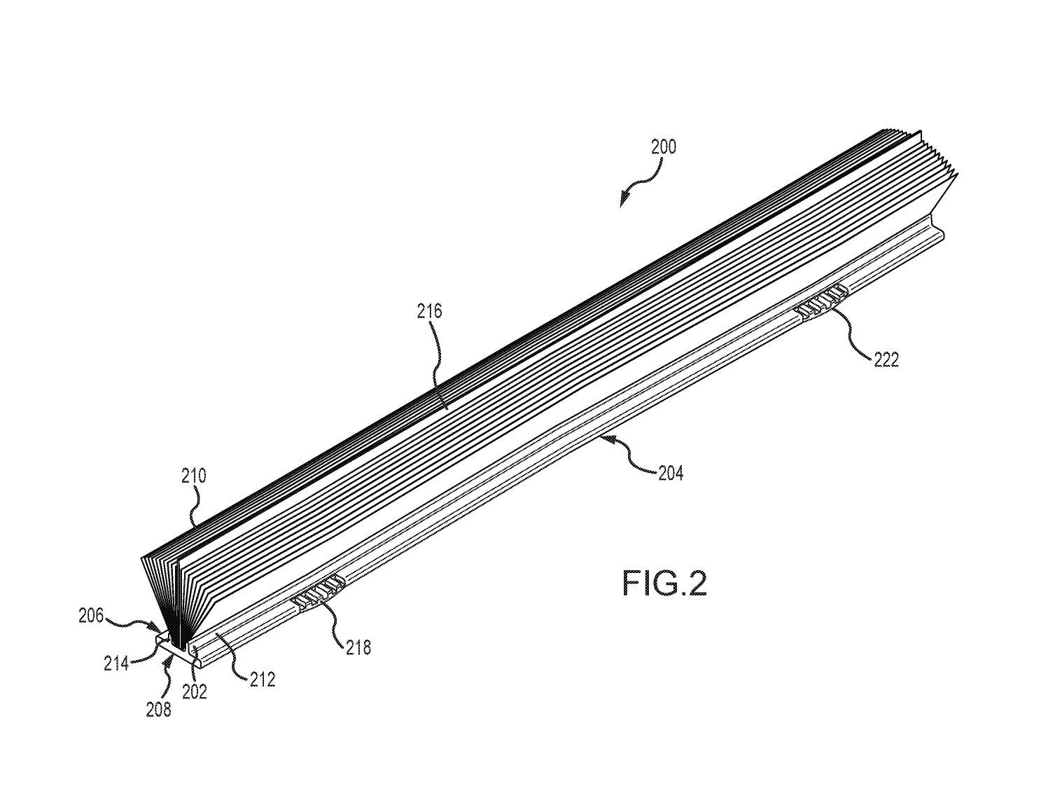

FIG. 2 depicts an example of a weatherstrip 100 incorporating the technologies described below. The weatherstrip 200 includes a backing strip 202 that includes outer edges 204, 206. A central portion 208 of the backing strip 202 is disposed between the two edges 204, 206, generally below a pile sealing element 210, which includes many individual fibers. Pile directors 212, 214 extend upwards from the backing strip 202 on either side of the pile 210 so as to form an outer boundary thereof. One or more sealing fins 216 may be present within the pile 210 to further limit air infiltration. The weatherstrip also includes deformations or tabs 218, 222 on either edge 204, 206 of the backing strip 202, as described below in more detail.

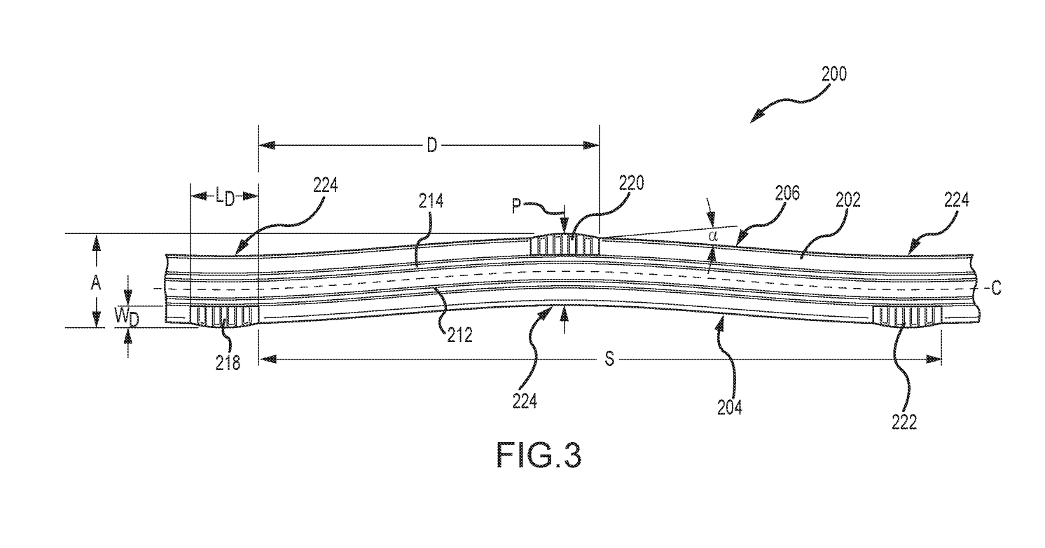

Further discoveries have been made in the field of pile weatherstripping that have resulted in significantly increased performance. It has been discovered that a number of factors can be used to influence the retention performance of weatherstrips. These factors are described in the context of FIG. 3, which depicts a top view of the weatherstrip 200 of FIG. 2, with the pile removed for clarity. The weatherstrip 200 includes a backing strip 202 that includes outer edges 204, 206. A central portion 208 of the backing strip 202 is disposed between the two edges 204, 206. Pile directors 212, 214 extend upwards from the backing strip 202 on either side of the pile (not shown). The weatherstrip also includes deformations or tabs 218, 220, 222 formed in edges 204, 206 of the backing strip 202. It has been discovered that properly sized and positioned deformations (such as deformations or tabs 218, 220, and 222) can cause a curve 224 to form on the portion of the backing strip 202 opposite the deformation 218, 220, 222. The deformations or tabs 218, 220, 222 and the resulting curves 224 cause the backing strip 202 to have a centerline C that is laterally undulating or wave-like in shape.

FIG. 3 also depicts relevant measurements of the weatherstrip 200. The backing strip 202 is characterized by a backing strip width W, which is the width of the backing strip 202 from an outer-most edge 204 to an outer-most edge 206. Three deformations or tabs 218, 220, 222 are depicted along the backing strip 202, although many more deformations may be included on longer weatherstrips. Each deformation has a deformation length L_{D}, measured substantially along a line parallel to an edge of the backing strip 202. Additionally, each deformation or tab has a deformation width W_{D}, measured substantially from the innermost limit of the deformation (proximate or at the pile deflector) to the outermost limit of the deformation. A deformation length L_{D} of about 100% to about 200% of a deformation width W_{D} has been discovered to produce desirable amplitude A. A protrusion distance P is measured from the outermost limit of a deformation or tab to the curved edge on the opposite side of the backing strip 202. Each deformation on a single side of the backing strip 202 (e.g., deformations or tabs 218 and 222) is separated by a spacing S. Additionally, an amplitude A is defined by the space between the outermost extent of a first deformation and the outermost extent of the next closest deformation on the opposite side of the backing strip 202 (e.g., between deformations 218, 220 or between deformations 220, 222). In examples, amplitudes A of about 120% to about 200% of the backing strip width W have been identified as being desirable. Ranges between about 150% and about 180% display promising results. An amplitude A of about 125% of the backing strip width W has also displayed desirable performance. It has been discovered that, by sufficiently deforming the backing strip 202 (e.g., with deformations or tabs 218, 220, 222, as well as additional deformations), a curvature may be formed on an opposite edge of the backing strip 202 from the deformation. This alternating curvature-deformation-curvature-deformation pattern, on opposing sides of the backing strip 202 results in a laterally undulating backing strip as depicted by undulating centerline C. This undulation generates a spring force when the backing strip 202 is inserted within a t-slot, the spring force being sufficient to retain the backing strip 202 therein.

Various factors may influence the amplitude A of the weatherstrip 200. Such factors include the size and shape of the deformations or tabs (e.g., 218, 220, 222, and so on), amount of tab projection beyond the edge of the backing strip 202, width W of the backing strip 202, the space S between tabs, and the included angle α along the edge of the backer 202 at the intersection of each tab 218, 220, 222, and so on. The amplitude A, in one example, is the dimension that represents total lateral space that the weatherstrip 200 occupies. Further, the factors that may influence the insertion, retention, and extraction forces include the number of tabs in contact with the t-slot per unit of length, the shape and size of the tabs, the backing strip 202 thickness and flatness, curvature of the backing strip 202 that results in spring pressure, amplitude A, which creates and undulating or zig-zag backing strip 202, and material surface finish.

When forming the deformations or tabs in the backing strip, punches that are perpendicular to the backer may increase the likelihood of creating an angular offset, zig-zag, and undulating form in the lateral direction of the backing strip. Due to the presence of the pile fibers, however, an embossing wheel mounted on the vertical plane would be likely to capture and distort the pile fibers. An embossing wheel mounted parallel to the backing strip has minimal positive effect on the amplitude A of the zig-zag effect. It has been discovered that an embossing wheel mounted at approximately 45 to 60 degrees from horizontal has an acceptable impact on the amount of amplitude generated.

The backing strip temperature during tab formation may be another relevant factor. Residual heat initially generated in the pile weatherstrip manufacturing process as the pile is welded to the backing strip may have a positive effect on the amount of offset generated by the embossing tool. The warm center portion of the backing strip may help the offsetting process due to the discovery that disruption of the pile director facilitates the linear distortion of the edge that results in an angular lateral undulation having an amplitude.

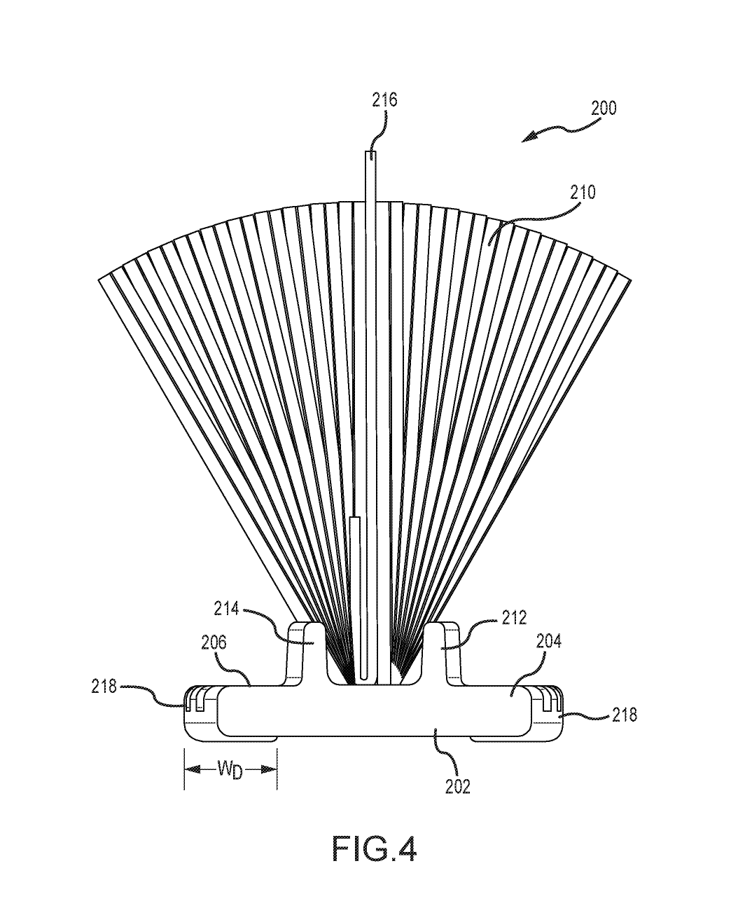

Disruption of the pile director has been discovered as another factor to facilitate the undulation of the backing strip. FIG. 4 depicts an end view of the weatherstrip 200 of FIG. 2. When viewed in cross-section, the pile directors 212, 214 form a U-shaped channel on the backer 202 in the center of the weatherstrip 200. When compressing a portion of the backer 202 that extends laterally from one of the pile directors 212, 214 to the edges 204, 206 of the backer 202, the two pile directors 212, 214 form a reinforced U-shaped channel that resists the linear deformation of the weatherstrip 200. It has been determined that upon weakening one of the pile directors 212, 214 on one side of the backer 202, linear deformation is facilitated and is easily accomplished by compressing the backer 202 with an embossing tool. Weakening of the pile directors 212, 214 can be accomplished mechanically by compressing, cutting, or otherwise manipulating its integrity structurally. As such, tabs 218 may be formed that have a width W_{D} extending completely from an edge 204, 206 to the pile director 212, 214. Weakening the pile directors 212, 214 can also be accomplished by heating the center portion of the backer 202, thereby softening the thermoplastic material that would otherwise reinforce the backer 202, making it somewhat resistant to angular deformation. Once the pile directors 212, 214 have been sufficiently weakened by structural or thermal means, the compression of a deformation 218 easily distorts the straightness of the backer 202 at the point of compression, thus causing a curvature on the opposite edge 204, 206, and forming the desired undulating effect. It is expected that tabs that extend substantially completely to the pile directors may also produce the desired undulation.

Referring again to FIG. 3, a higher deformation width W_{D}, as well as a higher deformation length L_{D}, both contribute to greater offset amplitude A. It can be desirable that the deformation width W_{D} reach from the very base of the pile row (e.g., proximate the pile director) to the outermost edge of the backer. In examples, this width W_{D} is approximately 0.050″. Embossing just a small portion of the edge of the backer, as described in U.S. Pat. No. 5,438,802, is not effective in creating the undulation in the backer. One desirable combination provides tab formation to between 50% and 95% of the backer thickness. Such a deformation width W_{D} may be for the full width from the pile director to the edge of the backer. Moreover, the tab spacing S may be every 1.5″ to 4″ on the same side. Since the tabs are spaced alternatively on opposite sides, the distance D between tabs on alternating sides is about 0.75″ to about 2″. Formation of tabs on only one side would also be effective. In examples, this distance D may be about 1000% to about 2000% of the deformation length L_{D}.

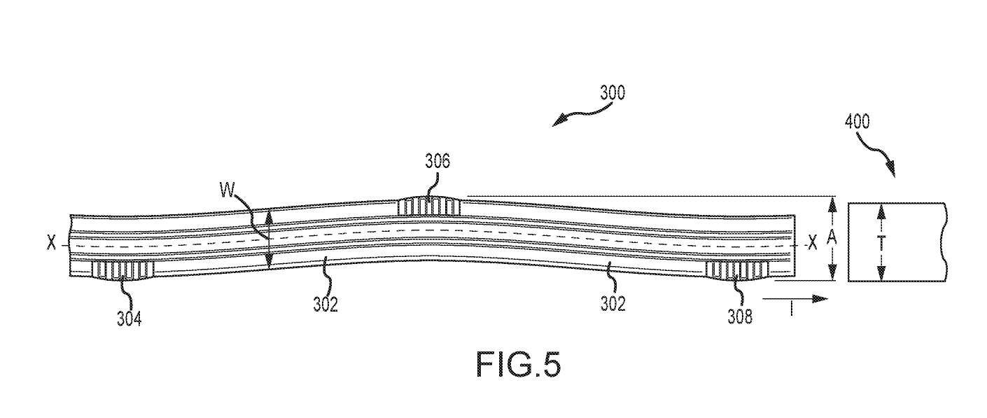

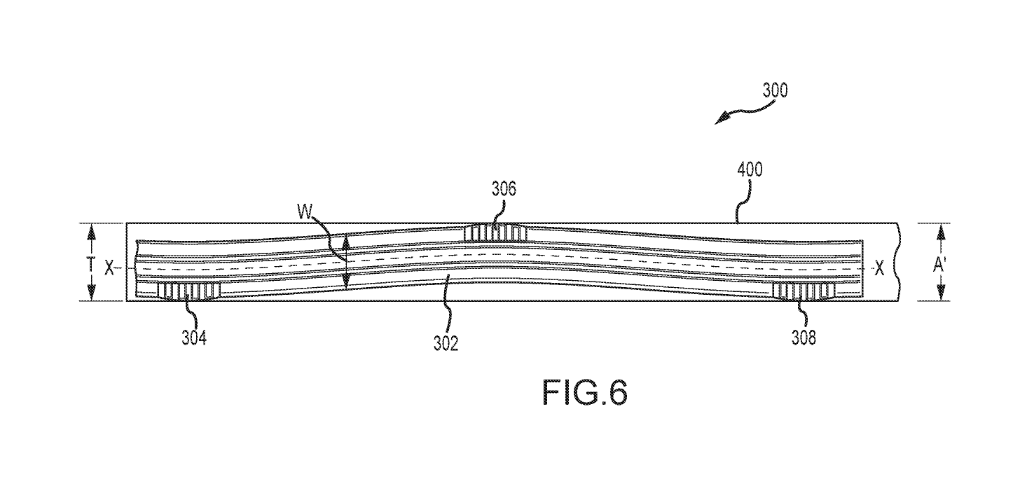

FIG. 5 depicts a top view of a weatherstrip 300 and a t-slot 400, prior to insertion I of the weatherstrip 300. The pile is not depicted on the weatherstrip 300 for clarity. The weatherstrip includes a backing strip 302 that includes deformations 304, 306, 308 as described herein. As can be seen, due to the deformations 304, 306, 308, the axis X has achieved an undulating shape desired to produce the spring force of the backing strip 302. The undulating shape of the axis X thus produces an amplitude A that is wider than a slot width T of the t-slot 400. The t-slot 400 also includes a throat (the portion of the t-slot 400 through which the pile extends), but the throat is not depicted for clarity. FIG. 6 depicts a top view of the weatherstrip 300 inserted into the t-slot 400. Due to the spring force generated by the undulation of the axis X, the inserted amplitude A′ is reduced to be the same as the width T of the t-slot 400. This spring force allows weatherstrips manufactured to the specifications described herein to be used in t-slots having different widths. This reduces the need to stock different sized weatherstrips and reduces the need for custom manufacturing for specific t-slot widths.

### Examples

T-slots commonly used in window manufacture have nominal widths between about 0.205″ to about 0.215″. In the examples, below, six-foot lengths were tested. It has been determined that removal forces of between about 0.7 pounds/linear foot and about 1.5 lb/lf are desirable. Removal forces of between about 0.7 lb/lf and about 1.0 lb/lf may be more desirable. Lower removal forces may result in the weatherstrip sliding out of the t-slot during window manufacture. Higher forces may prevent the weatherstrip from being removed.

A number of examples consistent with the teachings herein were made and tested. Table 1 presents the test results for a number of examples and includes the t-slot width T, backing strip amplitude A, tab spacing S, and removal force. In all cases, the deformations extend to and touch the pile director as described above. This results in the depicted amplitude. In all examples, six-foot lengths of weatherstrips were utilized.

TABLE 1
Sample Testing

| | T-slot | Backer | | | Removal | Removal |
|---|---|---|---|---|---|---|
| Sample | width T | width W | Amplitude A | Tab spacing S | force (lb.) | force/lf |
| A-1 | 0.202 | 0.187 | 0.235 | 2.11 | 8.9 | 1.48 |
| A-2 | 0.202 | 0.187 | 0.235 | 2.11 | 8.4 | 1.40 |
| A-3 | 0.202 | 0.187 | 0.235 | 2.11 | 7.1 | 1.18 |
| A-4 | 0.202 | 0.187 | 0.235 | 2.11 | 9.4 | 1.57 |
| A-5 | 0.202 | 0.187 | 0.235 | 2.11 | 8.5 | 1.42 |
| Average A | | | | | 8.5 | 1.41 |
| B-1 | 0.209 | 0.187 | 0.235 | 2.11 | 11.1 | 1.85 |
| B-2 | 0.209 | 0.187 | 0.235 | 2.11 | 15.3 | 2.55 |
| B-3 | 0.209 | 0.187 | 0.235 | 2.11 | 11.4 | 1.90 |
| B-4 | 0.209 | 0.187 | 0.235 | 2.11 | 9.3 | 1.55 |
| B-5 | 0.209 | 0.187 | 0.235 | 2.11 | 10.1 | 1.68 |
| Average B | | | | | 11.4 | 1.91 |
| C-1 | 0.210 | 0.187 | 0.235 | 2.11 | 4.5 | 0.75 |
| C-2 | 0.210 | 0.187 | 0.235 | 2.11 | 6.6 | 1.10 |
| C-3 | 0.210 | 0.187 | 0.235 | 2.11 | 4.8 | 0.80 |
| C-4 | 0.210 | 0.187 | 0.235 | 2.11 | 4.8 | 0.80 |
| C-5 | 0.210 | 0.187 | 0.235 | 2.11 | 4.9 | 0.82 |
| Average C | | | | | 5.1 | 0.85 |
| D-1 | 0.218 | 0.187 | 0.235 | 2.11 | 1.9 | 0.32 |
| D-2 | 0.218 | 0.187 | 0.235 | 2.11 | 4.4 | 0.73 |
| D-3 | 0.218 | 0.187 | 0.235 | 2.11 | 4.4 | 0.73 |
| D-4 | 0.218 | 0.187 | 0.235 | 2.11 | 4.4 | 0.73 |
| D-5 | 0.218 | 0.187 | 0.235 | 2.11 | 4.3 | 0.72 |
| Average D | | | | | 3.9 | 0.65 |

The results from Table 1 are indicative of the improved performance of the weatherstrips utilizing the undulating backing strip technologies described herein. The average result for test samples A-1 through A-5 is within the desirable 0.7-1.5 lb/lf range, while average result for test samples C-1 through C-5 is within the desirable 0.7-1.0 lb/lf range. It is believed that the test results for samples B and D may be improved by, e.g., adjusting the spacing S of the deformations and/or adjusting the size of the deformations. Other modifications consistent with the disclosure herein may also be made.

Methods of manufacturing a pile weatherstrip are described generally in U.S. Pat. No. 7,419,555, the disclosure of which is hereby incorporated herein in its entirety. The deformed and/or embossed pile weatherstrip technologies described further herein may be performed continuously on weatherstrip downstream of the processes described in the above-referenced patent, prior to a reel-up unit that packages the weatherstrip for storage and delivery. Deformation/embossing may be performed as the base portion of the weatherstrip cools (e.g., while still slightly molten). Linear speed of the weatherstrip can be approximately 45 to 60 feet per minute during manufacture. The deformation or embossing unit speed can be driven and timed independently from the machine that manufactures the pile weatherstrip. Alternatively, the embossing unit can be timed with traditional loop-control techniques using a “dancer arm” or Sona-trol™ sensing system to regulate and coordinate the speed of the embossing unit to the pile weatherstrip manufacturing machine. Alternatively, the weatherstrip may be deformed once the base portion has substantially cooled (e.g., at a facility remote from the where the weatherstrip was manufactured).

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A pile weatherstrip comprising:
an elongate base portion comprising a base portion width and a base portion amplitude greater than the base portion width; and
a pile extending from a central portion of the elongate base portion.

2. The pile weatherstrip of claim 1, wherein the base portion comprises a first deformation on a first side of the pile and a second deformation on a second side of the pile, and wherein the amplitude is measured from an outer limit of the first deformation to an outer limit of the second deformation.

3. The pile weatherstrip of claim 2, wherein the first deformation comprises a first deformation width extending from proximate the pile to the outer limit of the first deformation.

4. The pile weatherstrip of claim 3, wherein the first deformation comprises a first deformation length extending along the elongate base portion, wherein the first deformation length is greater than the first deformation width.

5. The pile weatherstrip of claim 1, further comprising a pile support extending from the elongate base portion, wherein the pile is bordered on at least one side by the pile support, and wherein the first deformation contacts the pile support.

6. The pile weatherstrip of claim 1, wherein the base portion amplitude is about 120% to about 200% of the base portion width.

7. The pile weatherstrip of claim 4, wherein the first deformation length is about 100% to about 200% of the first deformation width.

8. A weatherstrip comprising:
an undulating elongate base portion; and
a pile extending from a central portion of the undulating elongate base portion.

9. The weatherstrip of claim 8, wherein the undulating elongate base portion comprises an effective width greater than an actual width of the undulating elongate base portion.

10. The weatherstrip of claim 8, wherein the undulating elongate base portion comprises a non-linear centerline.

11. The weatherstrip of claim 8, wherein the undulating elongate base portion comprises a plurality of deformations, wherein outer limits of the plurality of deformations define an amplitude of the undulating elongate base portion.

12. The weatherstrip of claim 8, wherein the undulating elongate base portion undulates laterally.

13. The weatherstrip of claim 8, wherein the pile extends substantially orthogonal from the undulating elongate base portion.

14. A weatherstrip comprising:
a substantially uniform elongate base portion comprising:
a first edge;
a second edge; and
a first deformation formed in a portion of the first edge, wherein a portion of the second edge opposite the first deformation comprises a curvature.

15. The weatherstrip of claim 14, further comprising a second deformation formed in a portion of the second edge, wherein a portion of the first edge opposite the second deformation comprises a curvature.

16. The weatherstrip of claim 14, further comprising a pile extending from the substantially uniform elongate base portion and a pile director bordering the pile.

17. The weatherstrip of claim 16, wherein the deformation at least partially contacts the pile director.

18. The weatherstrip of claim 16, wherein the deformation comprises a textured surface of the substantially uniform elongate base portion.

19. The weatherstrip of claim 18, wherein the textured surface is formed in an upper surface of the substantially uniform elongate base portion.

20. The weatherstrip of claim 16, further comprising a fin disposed within the pile.
